(19) United States
(12) Patent Application Publication
(10) Pub. No.: US 2024/0004224 A1
(43) Pub. Date: Jan. 4, 2024

(54) SEMI-FINISHED OPHTHALMIC LENS FOR GLASSES AND THE LIKE

(71) Applicant: LUXOTTICA S.R.L., Agordo (BL) (IT)

(72) Inventors: Simone Luca TRAVERSO, Castiglione Torinese (TO) (IT); Daniele MASINO, Brusasco (TO) (IT); Marco ABBO, Orbassano (TO) (IT)

(21) Appl. No.: 18/253,697

(22) PCT Filed: Nov. 24, 2021
(86) PCT No.: PCT/IB2021/060925

§ 371 Date: May 19, 2023

(30) Foreign Application Priority Data
Nov. 30, 2020 (IT) 102020000028889

(51) Int. Cl. G02C 7/12; G02C 7/10; B29D 11/00

(52) U.S. Cl. CPC G02C 7/12; G02C 7/10; B29D 11/00009; B29D 11/00894; B29D 11/0073; B29D 11/00644; B29K 2069/00

(57) ABSTRACT

A semi-finished ophthalmic lens for glasses and the like, including a lens body, within which the at least one tint is defined, a body being over-injected onto the lens body, lacquering layers being respectively arranged to cover the lens body and the over-injected body and in which the at least one tint is made on the convex side, opposite to that of the wearer's eye.

### CROSS-REFERENCE TO RELATED APPLICATIONS

This application is a 35 U.S.C. § 371 National Stage patent application of PCT/IB2021/060925 filed 24 Nov. 2021, which claims the benefit of Italian patent application 102020000028889 filed 30 Nov. 2020, the disclosures of which are incorporated herein by reference in their entirety.

### TECHNICAL FIELD

The present disclosure relates to a semi-finished ophthalmic lens for glasses and the like. More particularly, the disclosure relates to a semi-finished ophthalmic lens of both polar and non-polar types.

### BACKGROUND

As known, ophthalmic lenses are normally used to correct visual impairments, aberrations and focusing deficiencies caused by the age of the person wearing the glasses.

In addition to correcting physiological vision problems, ophthalmic lenses and glasses using such lenses can also be used to improve physical or environmental conditions, e.g. glare, variable brightness, high brightness, presence of dust, etc., which may affect the subject's vision.

Tints can be added to ophthalmic lenses in order, on the one hand, to improve the appearance thereof, and on the other hand, to attenuate for example the light intensity that is conveyed to the user's eyes.

Ophthalmic lenses are known which do not provide for a tint arranged on the outer surface of the lens, but incorporated within the thickness of the lens itself.

Alternatively, the construction of an ophthalmic lens involves having a lens made of thermoplastic material (e.g. polyamide or acrylic polymers) over-injected onto it or made by means of a “casting” technique using thermosetting polymers.

In order to do this, the colouring to be imparted must be darker than the desired final one because the generating step involves the removal of material and, therefore, of the colouring.

In addition, as the plastic body has an optical power, the colouring must be checked with a specific lens, as a spectrophotometer is not sufficient. Said lens is of the “plano” type, with zero optical power.

### SUMMARY

The main task of the present disclosure is to make a semi-finished ophthalmic lens for glasses and the like, which has a tint (colouring) that is easier and quicker to be made than the known semi-finished lenses and which is protected against external agents and possible scratches.

Within the scope of this task, the present disclosure provides a semi-finished ophthalmic lens for glasses and the like which has a significantly reduced process time, with the same final colouring quality and less waste.

The present disclosure further provides a semi-finished ophthalmic lens wherein the tints (colourings) can be of any type or “pattern”, including but not limited to, classic gradient tint, circular tint, overlapping tint, sharp tint or shape tint.

The present disclosure also provides a semi-finished ophthalmic lens for glasses and the like, which can be functionalised, for example with a polarising layer.

The present disclosure further provides an ophthalmic lens for glasses and the like from a semi-finished ophthalmic lens whose colouring verification process can be carried out with a simple spectrophotometer.

Not least, the present disclosure provides a semi-finished ophthalmic lens for glasses and the like that is highly reliable, relatively simple to manufacture and competitively priced.

This task, as well as these and other advantages which will better appear later, are obtained by providing a semi-finished ophthalmic lens for glasses and the like, characterised in that it comprises a lens body, within which at least one tint is defined, a body being over-injected onto said lens body, lacquering layers being respectively arranged to cover said lens body and said over-injected body and wherein said at least one tint is made on the convex side, opposite to that of the wearer's eye.

Substantially, the present disclosure intends to make an ophthalmic lens which provides to have a semi-finished ophthalmic lens having, for example, a wafer (which could be functionalised in some cases), a preferably polycarbonate body over-injected thereon and a further over-injected body. The body, preferably made of over-injected polycarbonate, is coloured when it is in a semi-finished state and then it must undergo a “generating” process, i.e. it is thinned.

### BRIEF DESCRIPTION OF THE DRAWINGS

Further features and advantages of the disclosure will become clearer from the description of preferred but not exclusive embodiments of the semi-finished ophthalmic lens according to the disclosure, shown by way of indicative and non-limiting purposes, in the accompanying drawings, in which:

FIGS. 1a, 1b and 1c show in schematic view a first embodiment of a semi-finished ophthalmic lens according to the disclosure; and

FIGS. 2a, 2b and 2c show in schematic view a second embodiment of a semi-finished ophthalmic lens functionalised according to the disclosure;

FIG. 3a shows in schematic view a third embodiment of a semi-finished ophthalmic lens according to the disclosure;

FIG. 4a shows in schematic view a fourth embodiment of a semi-finished ophthalmic lens according to the disclosure.

### DETAILED DESCRIPTION OF THE DRAWINGS

With reference to the figures, the semi-finished ophthalmic lens according to the disclosure, in the first embodiment thereof, of non-polar type, is referred to by reference numbers 1a, 1b and 1c and comprises a lens body 2, preferably made of transparent or coloured polycarbonate, functionalised with broad-band pigments, narrow-band pigments, photochromic pigments, etc., within which at least one tint 3, 4 is present.

Suitably, a body 5 preferably made of transparent polycarbonate, which is adapted to be placed adjacent to the lens body 2, is over-injected onto the lens body 2.

Lacquering layers 6 and 7 are arranged to protect the lens body 2 and the over-injected body respectively. Advantageously, lacquering layers 6 and 7 are configured to filter ultraviolet radiation. Preferably, the lacquering layers 6 and 7 are configured to give the semi-finished ophthalmic lens a so-called “UV400” protection, i.e. a protection against UV-A, UV-B and intense sunlight.

Advantageously, one or more of the lacquering layers 6 and 7 may in turn comprise one or more lacquering sub-layers made of lacquers differing from each other. Preferably at least one of said lacquering sub-layers is configured to filter ultraviolet radiation.

Advantageously, as shown with reference to the first embodiment, the lacquering layer 6 covering the lens body 2 is contiguous to the lens body 2 itself.

Substantially, therefore, starting from the user's eye, referred to in the figures by reference number 13, the semi-finished ophthalmic lens comprises a first lacquering layer 7, the over-injected body 5 preferably made of polycarbonate, the lens body 2 and the further lacquering layer 6.

Advantageously, the lens body 2 is coloured, e.g. it is made of coloured polycarbonate, where the colouring of such lens body 2 occurs prior to the step of over-injecting the over-injected body 5.

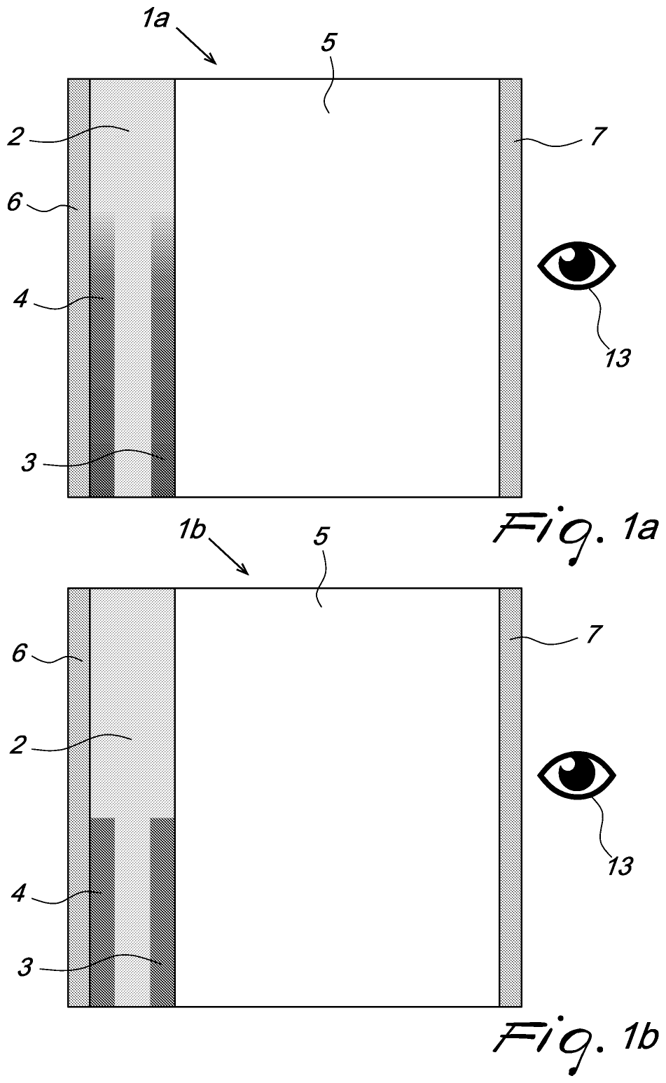

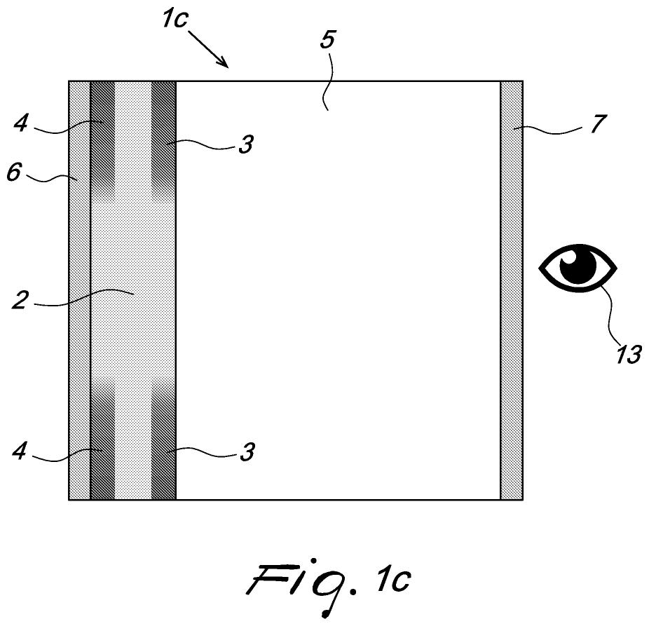

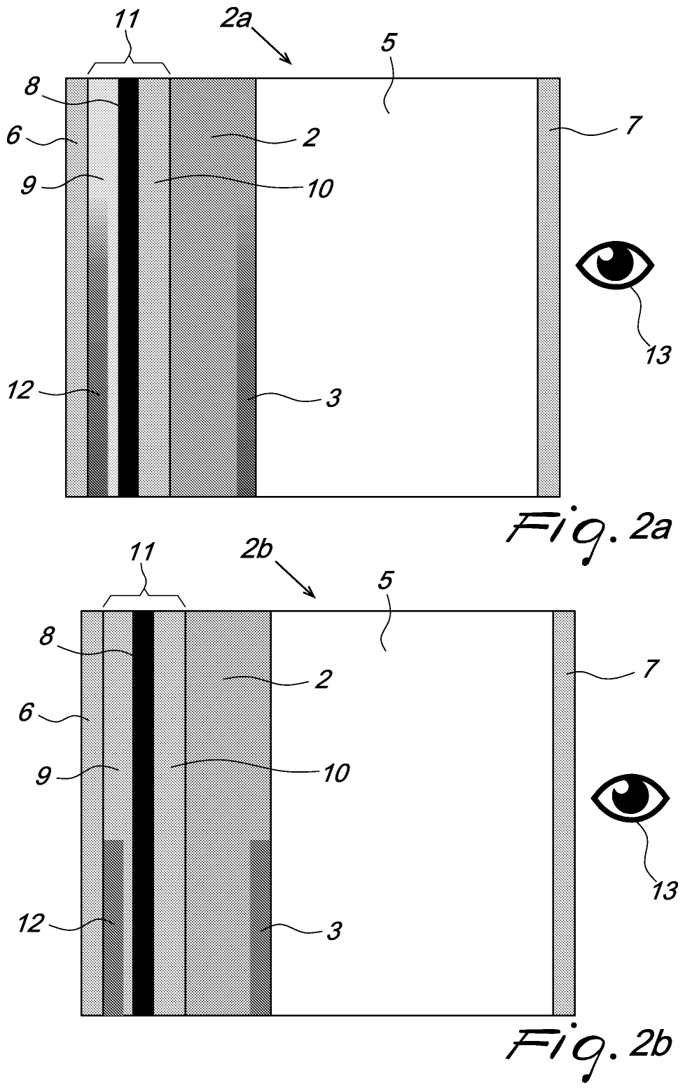

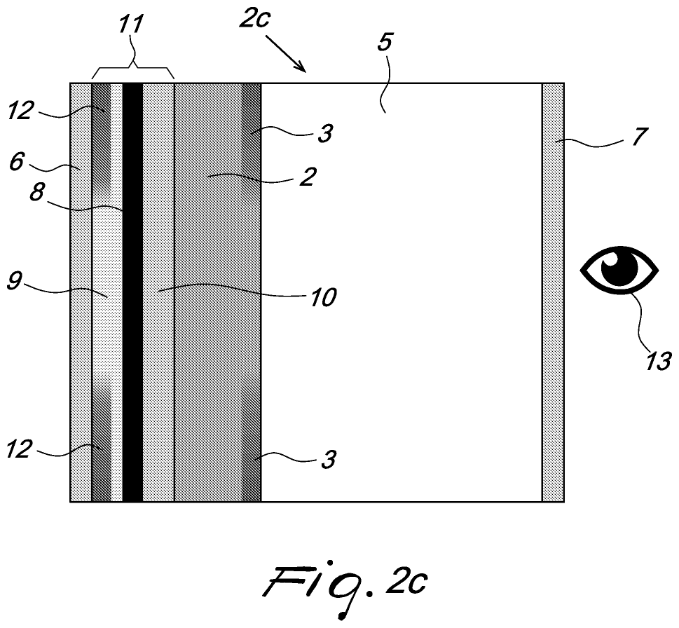

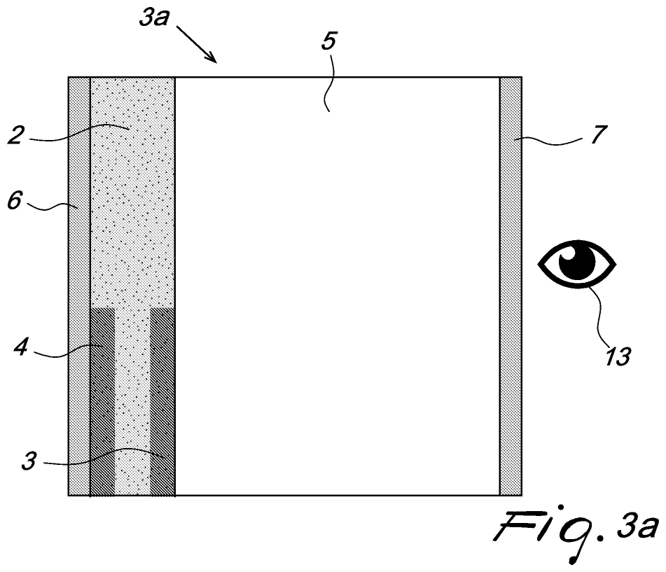

In the second embodiment of the semi-finished ophthalmic lens according to the disclosure, shown in FIGS. 2a, 2b and 2c, relative to a semi-finished ophthalmic lens of the polar type, and globally referred to by reference numbers 2a, 2b and 2c, and in which equal reference numbers are matched by equal elements, in addition to the layers already described for the first embodiment 1a, 1b and 1c of the semi-finished ophthalmic lens, shown in FIGS. 1a, 1b and 1c, a polarizing layer 8 is further present which is interposed between a first outer layer 9 preferably made of polycarbonate and a second inner layer preferably made of polycarbonate 10.

Layers 10, 8 and 9, in sequence from the user's eye 13 outwards, form a polarising wafer 11, to which the lens body 2 is suitably and previously over-injected.

The semi-finished ophthalmic lens 2a, 2b and 2c provides, similarly to the lens 1a, 1b and 1c, two outer lacquering layers 6 and 7, protecting the wafer 11 and the over-injected body 5 respectively.

Advantageously, as shown with reference to the second embodiment, the wafer 11 is interposed between the lacquering layer 6 covering the lens body 2 and the lens body 2 itself; in this case the lacquering layer 6 protects both the wafer 11 and the lens body 2.

Suitably, the lens body 2, preferably made of transparent or solid-coloured polycarbonate, functionalised (broad-band pigments, narrow-band pigments, photochromic pigments, etc.), comprises the tint 3 which is arranged adjacent to the over-injected body 5 and the outer layer 9, preferably made of polycarbonate, may also comprise a tint 12, made simultaneously with the tint 3.

Advantageously, with reference to the first and second embodiments of the semi-finished ophthalmic lens, the lens body 2 is made of polycarbonate by means of injection moulding techniques.

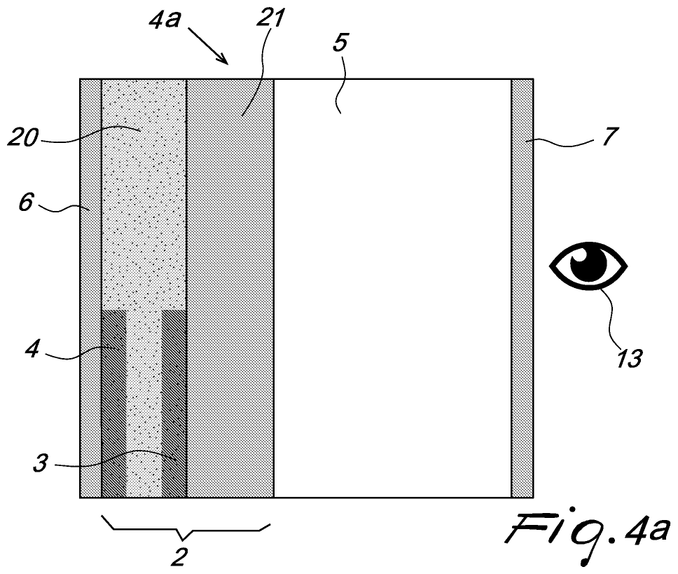

With reference to the third and fourth embodiments of the semi-finished ophthalmic lens, shown in FIGS. 3a and 4a respectively, the semi-finished ophthalmic lens according to the disclosure is referred to by reference numbers 3a and 4a respectively, and comprises a lens body 2 comprising at least one thermoformed non-polarizing wafer 20 within which at least one tint 3, 4 is present.

Advantageously, such a thermoformed non-polarizing wafer 20 is made of thermoformed polycarbonate, and preferably of transparent thermoformed polycarbonate.

In the third embodiment, shown in FIG. 3a, the lens body 2 consists exclusively of said thermoformed non-polarizing wafer 20, which therefore preferably forms a single layer of thermoformed polycarbonate.

In the fourth embodiment, shown in FIG. 4a, the lens body 2 comprises a further lens body 21 associated with said thermoformed non-polarizing wafer 20, preferably over-injected onto said thermoformed non-polarizing wafer 20.

Advantageously, the further lens body 21 is coloured, e.g. it is made of coloured polycarbonate, where the colouring of this further lens body 21 occurs prior to the step of over-injecting the over-injected body 5.

In this way, the further lens body 21 can give a colouring to the semi-finished ophthalmic lens 4a, despite the presence of a transparent thermoformed non-polarizing wafer 20.

In all the embodiments described, the tint (colouring) is made inside the lens body 2 and not in the over-injected body 5 of the lens (when it is in the semi-finished state).

Advantageously, the tint 3, 4, 12 is a classic gradient tint, or a circular tint, or an overlapping tint, or a sharp tint or a shape tint.

The present disclosure also relates to a process for making a semi-finished ophthalmic lens for glasses and the like, comprising the steps consisting in:
making at least one tint 3, 4 within a lens body 2, such as the one described above;
over-injecting onto this lens body 2, an over-injected body 5, such as the one described above;
arranging two lacquering layers 6, 7 to protect the lens body 2 and the over-injected body 5 respectively.

Advantageously the at least one tint 3, 4 is made inside the lens body 2 adjacent to the over-injected body 5.

Advantageously two tints 3, 4 are made inside the lens body 2.

Advantageously, the process produces a tint 12 in a polarising wafer 11 arranged between one of the lacquering layers 6 and the lens body 2.

Advantageously, the process comprises the step of colouring the lens body 2 before over-injecting the relevant over-injected body 5.

Advantageously, the process comprises the step of arranging a thermoformed non-polarizing wafer and the step of over-injecting the corresponding over-injected body 5, where said thermoformed non-polarizing wafer 20 constitutes, by itself or coupled with a further lens body 21, the lens body 2.

Advantageously, the process comprises the step of arranging a thermoformed non-polarizing wafer preferably transparent, the step of over-injecting a further lens body 21, preferably coloured, and the step of over-injecting the relevant over-injected body 5.

In practice, it has been proven that the semi-finished ophthalmic lens according to the present disclosure fully fulfils the task as well as the intended advantages, both in its polarised and non-polarised versions, as the tint made within the lens and not in the over-injected body allows it to be checked with a simple spectrophotometer and is quicker to produce.

The semi-finished ophthalmic lens thus conceived is susceptible to numerous modifications and variants, all of which fall within the scope of the attached claims.

Furthermore, all the details can be replaced by other technically equivalent elements.

In practice, the materials used, as well as the contingent shapes and dimensions, may be any according to requirements and to the state of the art.

1. A semi-finished ophthalmic lens for glasses comprising: a lens body, within which at least one tint is defined, a body being over-injected onto said lens body, lacquering layers being respectively arranged to cover said lens body and said over-injected body and wherein said at least one tint is made on a convex side, opposite to that of an eye of a wearer.

2. The semi-finished ophthalmic lens according to claim 1, further comprising a functionalised layer arranged between a first outer layer preferably made of polycarbonate and a second inner layer preferably made of polycarbonate, said second polycarbonate layer being arranged adjacent to said lens body.

3. The semi-finished ophthalmic lens according to claim wherein said functionalised layer is a polarizing layer.

4. The semi-finished ophthalmic lens according to claim 3, wherein said first outer layer made of polycarbonate, said polarizing layer and said second layer made of polycarbonate define a polarising wafer.

5. The semi-finished ophthalmic lens according to claim 1, wherein said lens body comprises at least two tints.

6. The semi-finished ophthalmic lens according to claim 4, wherein at least one first tint is made on the convex side, opposite to that of the eye of the wearer's eye, and at least one second tint is made on a concave side, on a side of the eye of the wearer's eye side.

7. The semi-finished ophthalmic lens according to claim 6, wherein one lacquering layer of said lacquering layers is arranged on the concave side, on the side of the eye of the wearer and adjacent to said over-injected body.

8. The semi-finished ophthalmic lens according to claim 2, wherein said first outer layer made of polycarbonate comprises a tint arranged therein.

9. The semi-finished ophthalmic lens according to claim 4, wherein a lacquering layer of said lacquering layers is arranged to protect said polarising wafer.

10. The semi-finished ophthalmic lens according to claim 1, wherein said at least one tint is arranged adjacent to the over-injected body, inside said lens body.

11. The semi-finished ophthalmic lens according to claim 1, wherein said lens body comprises at least one thermoformed non-polarizing wafer, preferably made of transparent polycarbonate, at least a tint being arranged within said thermoformed non-polarizing wafer.

12. The semi-finished ophthalmic lens according to claim 11, wherein said lens body comprises said thermoformed non-polarizing wafer.

13. The semi-finished ophthalmic lens according to claim 11, wherein said lens body comprises a further lens body associated with said thermoformed non-polarizing wafer, over-injected onto said thermoformed non-polarizing wafer.

14. A process for making a semi-finished ophthalmic lens for glasses, the process including the following step:
making at least one tint within a lens body,
over-injecting a body onto said lens body, and
arranging two lacquering layers to protect said lens body and said over-injected body respectively.

15. The process according to claim 14, wherein said at least one tint is made within said lens body adjacent to said over-injected body.

16. The process according to claim 14, wherein two tints are made inside said lens body.

17. The process according to claim 14, wherein making a tint in a polarizing wafer arranged between one of said lacquering layers and said lens body.

18. The process according to claim 14, further including the step of colouring said lens body prior to said step of over-injecting said over-injected body.

19. The process according to claim 14, wherein said step of making at least one tint within a lens body includes the steps of:
having a thermoformed non-polarizing wafer, and
making at least one tint within said thermoformed non-polarizing wafer.

20. The process according to claim 19, further including the step of over-injecting a further lens body, coloured, onto said thermoformed non-polarizing wafer.
